(19) United States
(12) Patent Application Publication
(10) Pub. No.: US 2008/0301157 A1
(43) Pub. Date: Dec. 4, 2008

(54) DATA STRUCTURE

(75) Inventors: John Anthony Beaven, Chandlers Ford (GB); Diego Oriato, Southampton (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/128,532

(22) Filed: May 28, 2008

(30) Foreign Application Priority Data
May 29, 2007 (EP) 07109140.0

(51) Int. Cl. G06F 17/30

(52) U.S. Cl. 707/100; 707/E17.001

(57) ABSTRACT

A data structure recorded in computer memory comprises a head reference, an ordered list of pages and an ordered list of elements. In the data structure, the head reference includes an address of a first page. Each page, except the final page, includes an address of a subsequent page. Each page includes a stored integer equal to the number of elements linked to the page, and an address of a first element in the page. Each element that is linked to a page, except the final element, includes an address of a subsequent element.

### BACKGROUND OF THE INVENTION

This invention relates to a data structure and more particularly to a high performance data structure for an immutable list.

In object-oriented computer programming, an immutable object is an object whose state cannot be modified after it is created. Immutable objects can be useful in multi-threaded applications, where different threads will access objects simultaneously. Multiple threads can act on the data represented by an immutable object without the concern that the data will be changed by other threads. Immutable objects are therefore considered to be more “thread-safe” than mutable objects. Moreover, immutable objects do not need to be locked, and so the overhead of enforcing mutual exclusion (i.e., preventing concurrent use of a common resource in a multithreaded environment) is avoided.

An immutable list is an ordered collection of elements. The state of the immutable list, defined as order and identity of its elements, cannot be modified. However, attributes of elements inside the list can still be modified as long as these elements are mutable objects. The immutability of the list can be achieved in two ways, firstly by preventing any operation that modifies the state of the list using compile-time constructs, or secondly, by defensive copying of the entire list at run-time (copy-on-write). Using the copy-on-write technique, when a thread modifies the list through a particular reference, the system makes a real copy and sets the reference to refer to the new copy. The other threads are unaffected, because they still refer to the original list. The copy-on-write technique blends the advantages of mutable and immutable lists. A classic example of an immutable list is an instance of the Java String class.

Current logging and security applications require huge thread-safe collections and fast algorithms for comparing them. When a list contains a large amount of data, the cost of a few changes might become prohibitive since a full copy of the list has to be made. Even for rarely-changing collections, many current applications require fast search and comparison algorithms.

### BRIEF SUMMARY OF THE INVENTION

The present invention may be embodied as an apparatus that includes a memory that contains a data structure comprising a head reference, an ordered list of pages and an ordered list of elements. Each of said elements is linked to one of said pages. The head reference includes an address of a first page in said ordered list of pages. Each page includes an integer value and, for every page other than the last page, an address for the next page in said ordered list of pages. Each element linked to a given page, other than the last element linked to the page, includes an address for the next element linked to the same page.

The present invention may also be embodied as computer program product for recording a data structure comprising a head reference, an ordered list of pages and an ordered list of elements with each of the elements being linked to one of the pages. The computer program product includes a computer usable medium with computer usable program code recorded thereon and being configured to record, in said head reference, an address of a first page in said ordered list of pages; to record an integer value for each page; to record, for each page other than the last page, an address for the next page in said ordered list of pages; and to record, for each element linked to a given page other than the last element linked to the page, an address for the next element linked to the same page.

### BRIEF DESCRIPTION OF THE SEVERAL VIEWS OF THE DRAWINGS

FIG. 1 is a schematic diagram of a conventional data structure.

FIG. 2 is a schematic diagram of a novel data structure.

FIG. 3 is a schematic diagram of the data structure of FIG. 2, following the addition of a new element.

FIG. 4 is a schematic diagram of the data structure of FIG. 2, following the insertion of a new element.

FIG. 5 is a further schematic diagram of the data structure of FIG. 2.

FIG. 6 is a graph showing the performance of the data structure of the type shown in FIG. 2 compared to a conventional data structure of the type shown in FIG. 1.

FIG. 7 is a graph of CPU consumption in a single add/delete cycle.

FIG. 8 is a graph of memory allocation in a single add/delete cycle.

FIG. 9 is a flowchart of a method of creating a data structure.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

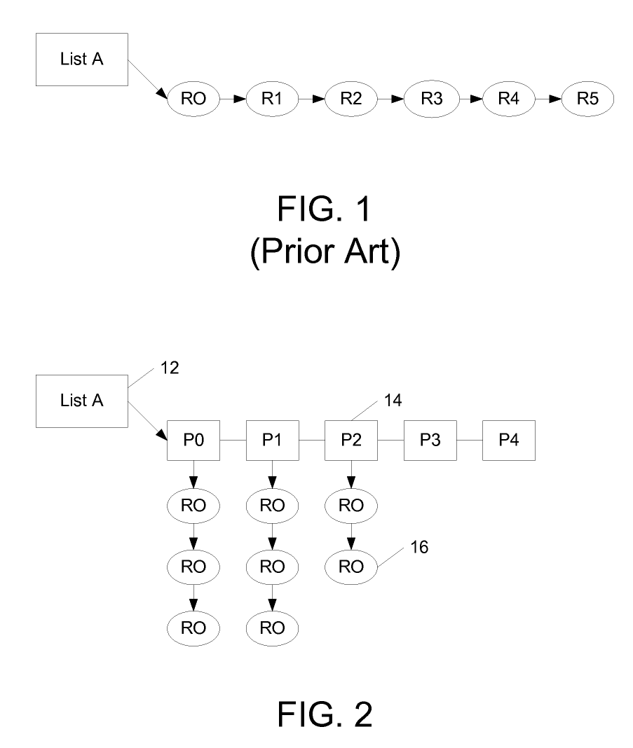

FIG. 1 shows a standard representation of a data structure that is a list. The data structure comprises a head reference labeled “List A” and an ordered collection of elements (R0, R1 . . . R5).

Owing to the invention, it is possible to provide a data structure that is optimized for very long immutable lists. The data structure decomposes a conventional list into sublists called “pages” which are then chained together to form the complete list. By employing techniques involving page reuse between different instances of lists, the implementations are able to ensure that duplicate copies of pages are only created where necessary. Although a small overhead in memory allocation is necessary for the paged structure, the benefits in speed and memory allocation during add and delete operations is dramatic. A performance study carried out on the new data structure shows a six times speed boost compared to a conventional list.

The “paged” approach also supports optimization of comparing and hashing algorithms. For example, during a comparison of two lists, shared pages will be checked only by the equality of their references. Moreover, pages could contain a check-sum value of all the hash values of the elements in the page, boosting the execution speed of the equality test also for not shared pages.

FIG. 2 shows a first embodiment of the new data structure 10. The data structure 10 comprising a head reference 12, an ordered list of pages 14 and an ordered list of elements 16. The principle of the data structure 10 is that the elements 16 of the structure are divided into sublists, formed by the pages 14. FIG. 2 represents a list containing eight elements. The list is made of five pages: P0, P1, P2, P3 and P4. Each page 14 contains a limited (capped) number of elements. In FIG. 2 this maximum is set to three elements.

The data structure is created so that the head reference 12 comprises an address of a first page (P0) and each page 14, except the final page (P4), includes an address of a subsequent page 14. Each page 14 includes a stored integer equal to the number of elements 16 linked to that page 14. Each page 14 having elements 16 linked to it includes an address of the first linked element 16. For example, in the case of page P0, the address of element R0 is stored by that page. Each element 16 that is linked to a page 14, except the final element 16, includes an address of a subsequent element 16.

The data structure 10 shown in FIG. 2 is an example of a data structure 10 that has only a relatively small number of elements 16. In many practical situations, data structures with hundreds or many thousands of elements 16 are possible. The page size used will reflect the overall number of elements 16 in the data structure, in order to keep the number of pages 14 to a relatively low number. For example, a data structure 10 with one thousand elements 16 may have twenty pages of fifty elements each. A significant advantage of the data structure 10 is that in these very large structures, access to a specific element is greatly speeded up.

In the conventional list of FIG. 1 every element between R0 and a desired element has to be traversed to reach the desired element. In the structure 10 of FIG. 2, however, it is only necessary to traverse through the pages 14 until the correct page 14 is reached and then through the elements 16 linked to that page 14 to find the desired element 16. This is achievable because the elements 16 are ordered, and each page 14 stores an integer equal to the number of linked elements 16. So if element number 302 is sought and the page size is 100, then a route through P0 and P1 to P2 is traversed and then to the element 302, which is linked to P2. This is much faster than traversing all 302 elements to reach the desired element.

In a preferred embodiment, the data structure 10, in relation to those pages 14 having linked elements 16, is constructed so that the stored integer for each page, except the final page, is identical. This means that all of the pages, except the last page (P2 in FIG. 2) have the same number of elements 16 linked thereto. The data structure 10 can be created such that it further comprises a maximum value, wherein the stored integer for each page 14 cannot exceed the maximum value. The maximum value can be generated according to an algorithm using the number of elements in the ordered list of elements. For example if a list of x elements is being converted into the data structure 10 of FIG. 2, then the algorithm could determine that the maximum number of elements 16 per page 14 be equal to x/20. The maximum value can be dynamically changed according to any change in the number of elements in the ordered list of elements.

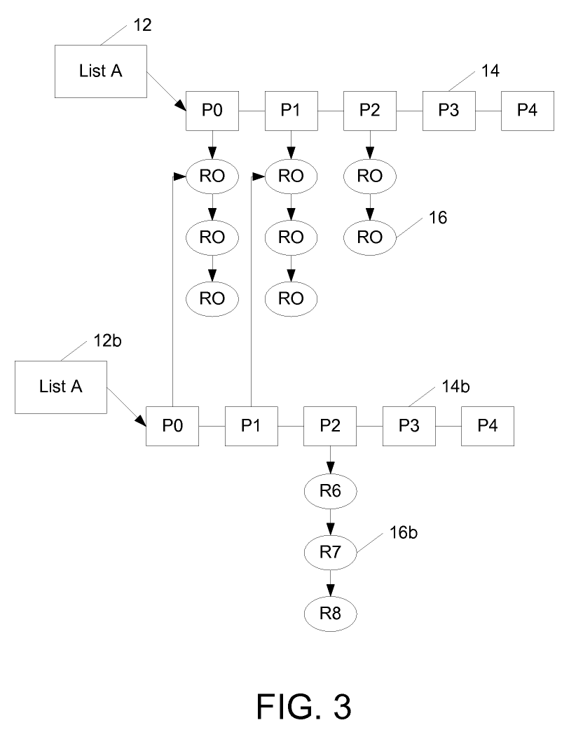

A second significant advantage of the data structure 10 is that if a new structure is created following a change such as an addition of an element, which creates a new structure, then this can be stored extremely efficiently. FIG. 3 shows a new List B obtained as result of appending an element R8 at the end of List A. The list A is an immutable list, so if a user or program makes a change to the list, then a new list must be created that reflects the change, as the original list must be available to those resources that need to access the original list in thread-safe manner.

In FIG. 3 there is the appending of an element: List B=List A.add(R8). List A and List B share both page P0 and P1 but have a different copy of page P2. The rationale behind this is that a page needs to be physically copied only when it changes. This saves memory space and instructions. In the worst scenario only one page will be copied. The data structure 10 now further comprises a second head reference 12b, a second ordered list of pages 14b and a second ordered list of elements 16b. The second head reference 12b comprises an address of a first page (P0 of 14b) in the second ordered list of pages 14b. As before, each page 14b, in the second ordered list of pages 14b, except the final page (P4 of 14b), includes an address of a subsequent page 14b, in the second ordered list of pages 14b, and each page 14b includes a stored integer equal to the number of elements 16 or 16b linked to the page 14b, as well as the address of a first element. In the structure 10 of FIG. 3, one or more pages 14b link to an element in the first ordered list of elements 16 while one or more pages 14b link to an element in the second ordered list of elements 16b.

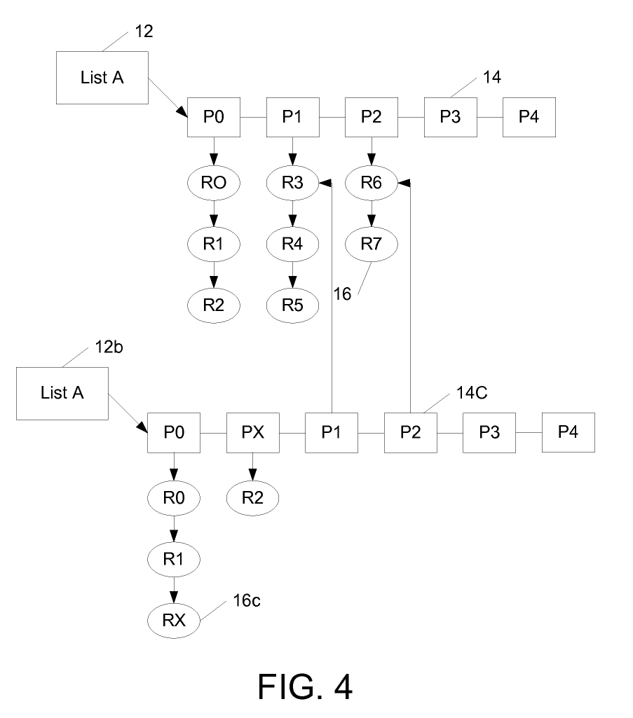

If a user or program that is accessing the data structure 10 wishes to insert a new element in the ordered list of elements, then a new list will be created. FIG. 3 showed how the data structure 10 would change if a new element were to be added at the end of the list of ordered elements. FIG. 4 shows how the data structure 10 would be modified when a new element is to be inserted within the list of ordered elements. If a user or program wished to insert element RX at index 2 (=third position) of list A, then the end result would be the new list C shown in FIG. 4. The insertion in the list could be characterized as: List C=List A.add(2,RX). Following the insertion, a new page PX would be added in List C to contain the overflow of page P0 caused by the insertion. The new head reference 12c refers to new page P0 of the new ordered pages 14c. Likewise a small number of new elements 16c are created to accommodate the insertion. The vast majority of the pages in the new list C will refer back to the existing elements 16, without the need for any copying to take place.

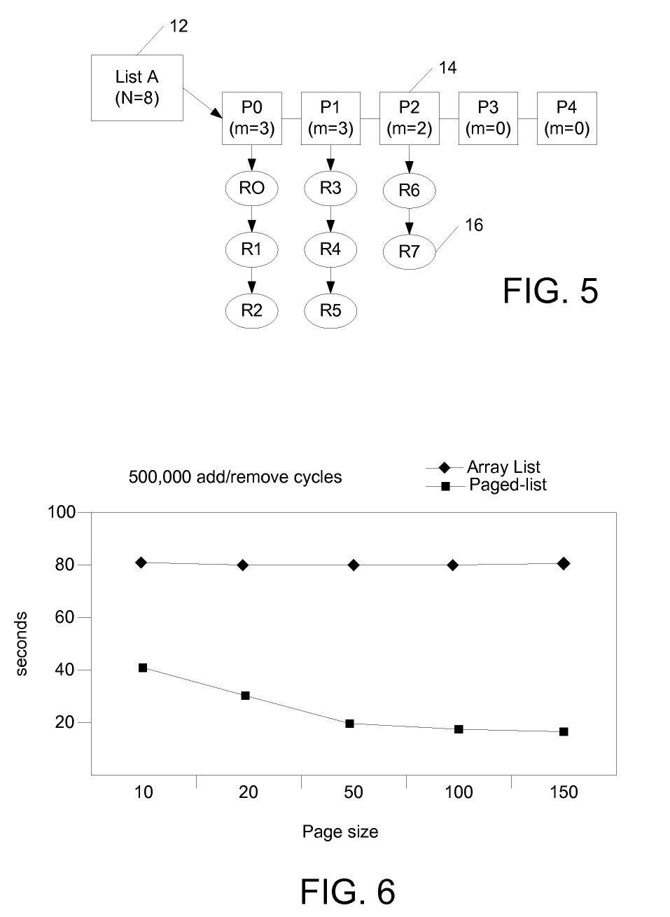

The naming and numbering of pages 14 and reference elements 16 are irrelevant to the logical and relative positioning of the elements 16. The index position of each element 16 will not be hard-coded in the list elements but will be calculated as the list is scanned. As shown in FIG. 5, there exists only two counters: one in the list object (the head reference 12) reporting the total number of elements contained in the list (N), and the other in each page 14 reporting the number of elements (m) included in that particular page.

Deletion operations that are performed on the data structure 10 will follow a pattern similar to addition methods: the page where the element has to be deleted will be copied and the element removed. If the page becomes empty, then the page will be removed all together. A new list is created which effectively has a new ordered list of pages, again all or all except one, being linked to the elements in the original list.

It is easy to carry out a ListA.append(List B) operation. The new list will be constituted by the pages of List A followed by those ones of List B. No copying of elements is needed. In order to improve appending operations, the list object will contain also a pointer to the last non-empty page so that it won't be necessary to scan the full length of the list while appending an element.

The data structure can be searched with a find method of the list in the form of a simple linear search. The page size is a parameter that could be specified when constructing the list. It is possible to implement an autonomic behavior where the page size changes as the list grows.

FIGS. 6, 7 and 8 relate to preliminary performance testing on a prototype of the paged-list coded in Java. The scenario that was tested was a pre-built list containing 1000 elements. The test consisted of alternate add( ) and remove( ) calls. Additions were made at the end of the list. Removes were performed using a random index. The test was run 500,000 times, i.e. half million inserts and half million delete. The objects that were inserted in the list were of the type java.lang.Integer. As a reference list there was used a java.util.ArrayList, where the immutability is achieved by the copy-on-write technique.

FIG. 6 shows a graph of the insert/delete cycles on a 1000-elements list varying the page size. The graph shows that the paged-list is capable of being modified 71,000 times per second with a page size of 100. The simple ArrayList implementation can only achieve 12,000 copies per second, almost 6 times slower. Optimization in page size is clearly dependent on the list length and on the size of its elements. However there is a wide range of page size values in which performance is very close to the optimum. Page size and page rebalancing can be adjusted at runtime while the list grows and/or by a background process. When the page size is small, it is more expensive to scan the list to find the right page to modify than to copy the page before modifying it. As the page size is increased, the balance is reversed. The best page size appears to be dependent on the size of the list.

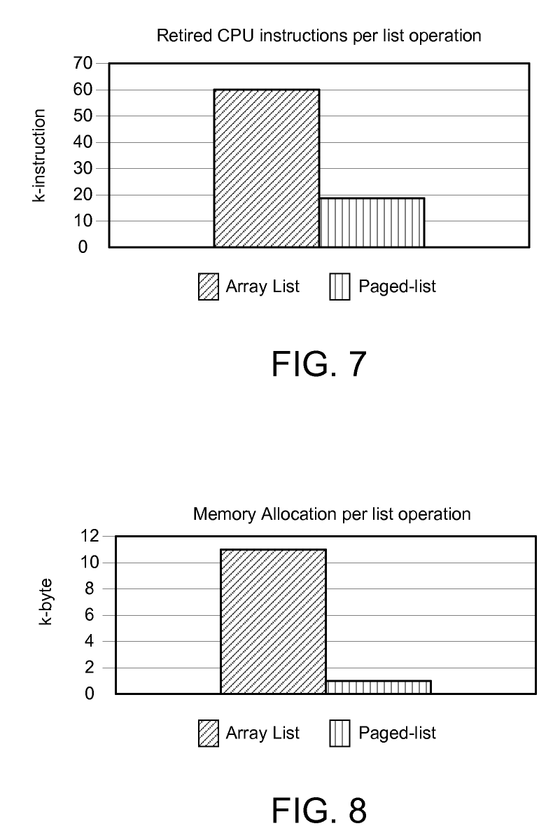

FIG. 7 and FIG. 8 show CPU consumption and memory allocation in a single add/delete cycle. In each Figure, the performance of the ArrayList is on the left and the performance of the paged list (the data structure 10) is on the right. Again the paged list has a considerable advantage. FIG. 7 shows the CPU kilo-instructions required to run one insert/delete cycle with page size of 100, with the ArrayList requiring approximately three times as many as the paged list. FIG. 8 shows memory allocation cost in kilobytes for an insert/delete cycle with page size of 100. The paged list outperforms the ArrayList by a factor of ten.

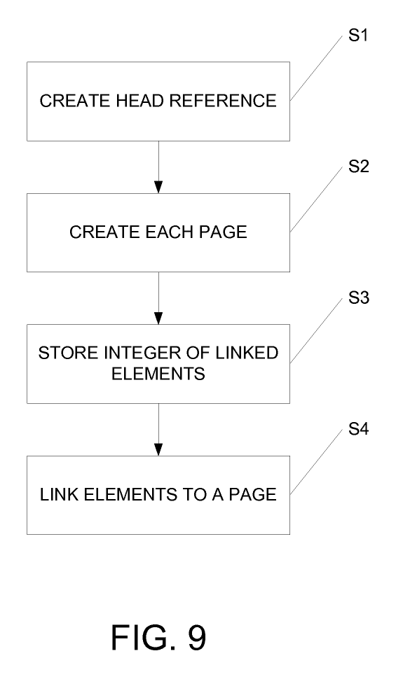

FIG. 9 summarizes the method of creating the data structure 10. The data structure comprising the head reference 12, the ordered list of pages 14 and the ordered list of elements 16. The method comprises the steps of creating, at step S1, the head reference, which includes an address of a first page, At step S2, each page is created with each page, except the final page, including an address of a subsequent page. In step S3, an integer is stored in each page with the integer being equal to the number of elements linked to the page. Similarly, the address of the first element on each page is stored. Finally, in step S4, the elements on each page are linked with each element in the page, except the final element, including an address of a subsequent element. The method for creating the data structure may be executed as a computer program product (a software application) stored on a computer readable medium such as a CD-ROM. Similarly, the data structure itself may be recorded on a computer readable medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. Apparatus containing a memory that contains a data structure comprising a head reference, an ordered list of pages and an ordered list of elements, each of said elements being linked to one of said pages, wherein:
said head reference comprises an address of a first page in said ordered list of pages;
each page comprises an integer value;
each page, other than the last page, comprises an address for the next page in said ordered list of pages; and
each element linked to a given page, other than the last element linked to the given page, comprises an address for the next element linked to the same page.

2. The apparatus of claim 1 wherein the integer value represents the maximum number of elements that can be linked to a page.

3. The apparatus of claim 1 wherein the integer value included in each page is identical to the integer value included in every other page, except the last page in said ordered list of pages.

4. The apparatus of claim 3 wherein the number of elements linked to each page is determined by dividing the number of elements by the number of pages with any remainder being linked to the last page in said order list of pages.

5. The apparatus of claim 1 wherein the data structure further comprises a second head reference, a second ordered list of pages and a second ordered list of elements, each of said elements being linked to one of said pages in said second ordered list of pages, wherein:
said second head reference comprises an address of a first page in said second ordered list of pages;
each page in said second ordered list of pages, other than the last page, comprises an address for the next page in said second ordered list of pages;
each page in said second ordered list of pages comprising a stored integer equal to the number of elements linked to the page and an address of a first element;
at least one of said pages linking to an element in said first ordered list of elements; and
at least one of said pages linking to an element is said second ordered list of elements.

6. A computer program product for creating a data structure comprising a head reference, an ordered list of pages and an ordered list of elements, each of said elements being linked to one of said pages, said computer program product having a computer usable medium with computer usable program code recorded thereon, said computer usable program code comprising:
computer usable program code configured to record, in said head reference, an address of a first page in said ordered list of pages;
computer usable program code configured to record an integer value for each page;
computer usable program code configured to record, for each page other than the last page, an address for the next page in said ordered list of pages; and
computer usable program code configured to record, for each element linked to a given page other than the last element linked to the given page, an address for the next element linked to the same page.

7. The computer program product of claim 6 wherein the recorded integer value represents the maximum number of elements that can be linked to a page.

8. The computer program product of claim 6 wherein the integer value recorded for each page is identical to the integer value recorded for every other page, except the last page in said ordered list of pages.

9. The computer program product of claim 8 further comprising computer usable program code configured to establish the number of elements linked to each page by dividing the number of elements by the number of pages with any remainder being linked to the last page in said order list of pages.

10. The computer program product of claim 6 further comprising computer usable program code configured to record a second head reference, a second ordered list of pages and a second ordered list of elements, each of said elements being linked to one of said pages in said second ordered list of pages, wherein:
said computer usable program code configured to create a second head reference further comprises computer usable program code configured to include an address of a first page in said second ordered list of pages in said second head reference;
said computer usable program code configured to create each page in said second ordered list of pages, other than the last page, further comprises computer usable program code configured to include an address for the next page in said second ordered list of pages;
said computer usable program code further comprises computer usable program code configured to include, in each page in said second ordered list of pages, a stored integer equal to the number of elements linked to the page and an address of a first element;
at least one of said pages in said second ordered list of pages linking to an element in said first ordered list of elements; and
at least one of said pages in said second ordered list of pages linking to an element is said second ordered list of elements.
